(19) United States
(12) Patent Application Publication
(10) Pub. No.: US 2022/0035901 A1
(43) Pub. Date: Feb. 3, 2022

(54) DATA STORAGE MEANS CONTROL APPARATUS AND METHOD HAVING DATA PROTECTION FUNCTION BY USING WIRELESS COMMUNICATION WITH SMARTPHONE

(71) Applicant: STORAGEAN, INC., Seongnam-si (KR)

(72) Inventor: Dong Goo YUN, Seoul (KR)

(21) Appl. No.: 17/278,979

(22) PCT Filed: Sep. 10, 2019
(86) PCT No.: PCT/KR2019/011675

§ 371 Date: Mar. 23, 2021

(30) Foreign Application Priority Data
Sep. 28, 2018 (KR) 10-2018-0116083

(51) Int. Cl. G06F 21/35; G06F 21/32; G06F 21/71; G06F 3/06

(52) U.S. Cl. CPC G06F 21/35; G06F 21/32; G06F 3/0689; G06F 3/0622; G06F 3/0637; G06F 21/71

(57) ABSTRACT

Provided is a data storage control apparatus and method having a data protection function by using wireless communication with a smartphone, the apparatus comprising: a connector and a control unit which are connected to a host computer inside the data storage control apparatus; and a bus switch capable of connecting or disconnecting a main data bus between the control unit and the data storage or a connection connector to which the data storage is connected, wherein the bus switch is connected to an on/off control pin of a wireless communication unit provided inside the data storage control apparatus. The wireless communication unit is connected to the smartphone of a user by a wireless interface such as Bluetooth or WiFi through an antenna.

### TECHNICAL FIELD

When a data storage means control apparatus having a data protection function by using wireless communication with a smartphone is installed and used in a computer, the present invention relates to a technology for preventing a disk from being accessed by maintaining a bus switch provided in a data storage means of the present invention in an off state while the data storage means control apparatus is not used in the computer. The present invention relates to a technical field of a data storage means control apparatus having a security function embedded therein, which operates in a manner in which a user transmits, to a wireless communication unit provided in the data storage means control apparatus, bit information that is distinguished into an authorized person or an unauthorized person as a result of a separate screen manipulation or a user's biometric recognition result that allows the user to access the data storage means control apparatus on a smartphone used by himself/herself when the access to use the data storage means control apparatus is generated and by which the wireless communication unit transmits the bit information as an output signal of a pin for controlling a bus switch to turn the bus switch on or off, thereby connecting the data storage means control apparatus to a computer by a main data bus to permit the access to the data storage means control apparatus or blocking the data storage means control apparatus from being connected to the computer to release the access to the data storage means control apparatus.

### BACKGROUND ART

Patent Application No. 10-2017-0094492 (filing date 2017 Jul. 26) and Patent Application No. 10-2018-0025264 (filing date 2018 Mar. 2) filed by the applicant of the present application are solid state drive (SSD)-based storage media having a data protection function. The storage media is illustrated in the attached FIGS. 1 to 6.

FIG. 1 is a block configuration diagram of an SSD doubler 1 including a first connector unit 11 for one main interface and a second connector unit 25 for a password and a status information interface according to the related art, and the first connector unit 11 is usually connected to a serial advanced technology attachment (SATA) connector (not illustrated) provided on a motherboard (not illustrated) of a desktop personal computer (PC).

A second control unit 21 is constituted as a controller of redundant arrays of inexpensive disk (RAID) and is connected to storage media 41 and 43 through a series of connector units 35, 37, and 39.

The second connector unit 25 is directly connected to a universal serial bus (USB) port (not illustrated) provided on a rear input/output (I/O) panel (not illustrated) of the desktop PC or is connected to a USB connector (not illustrated) provided on a peripheral component interconnect express (PCIe) add-in card (not illustrated) that supports a USB interface.

The second connector unit 25 converts a USB signal into a level of a digital signal such as +3.3 V by a signal conversion unit 27 and inputs the digital signal to a first control unit 29.

The first control unit 29 permits or blocks access to the storage media 41 and 43 connected through the second control unit 21 in a manner in which the first control unit 29 is connected to an on/off input pin of a bus switch 19 to perform an on/off operation according to control of a user interface and a device driver installed inside the desktop PC.

FIG. 2 is a block configuration diagram of an SSD tripler 50 including a plurality of connector units 51, 61, and 69 for a main interface and a connector unit 77 for a password and a status information interface according to the related art, and the SSD tripler 50 does not include the second control unit 21 such as the separate RAID controller, unlike FIG. 1, but has a structure in which interface connectors 51, 61, and 69 for a series of main data buses each exposed to the outside to be connected to a computer correspond to storage media 59, 67, and 75 through connectors 57, 65, and 73 corresponding to bus switches 55, 63, and 71, respectively, and performs an operation to permit or block access to the connected storage media 59, 67, and 75 in a manner in which the bus switches 55, 63, and 71 are each turned on/off according to the control of the user interface and the device driver installed on the computer provided with the SSD tripler 50 by inputting on/off output signals of the bus switches 63, 55, and 71 to a first control unit 81 as in FIG. 1 through a seventh connection unit 77 and controlling the bus switches 55, 63, and 71 according to the on/off output signals for the bus switches 55, 63, and 71, respectively, of the first control unit 81.

FIG. 3 shows a perspective view and a front view of the SSD doubler 1 according to the related art, and the SSD doubler 1 includes the first connector unit 11 to which a main data bus and a power cable (not illustrated) are connected and the second connector unit 25 that is connected to a USB port provided on a rear I/O panel of the desktop PC on a side thereof and is connected to the USB connector (not illustrated) provided on the PCIe Add-in card (not illustrated) for a USB interface provided in a PCIe slot of the desktop PC.

The first storage media 41 and the second storage media 43 are respectively coupled to a fourth connector unit 39 and a fifth connector unit 37 provided on the inside in a sliding manner along guides of bay supports 45-1 and 45-2 to form a two-stage stack, and functions such as RAID0 (Strip), RAID1 (Mirror), and CLONE are performed according to a configured state of the second control unit 21 that is physically separated but logically provided therein.

FIG. 4 shows a perspective view and a front view of an SSD tripler 50 according to the related art. The SSD tripler 50 is configured in a form in which a first connector unit 51 that is connected to a main data bus and a power cable (not illustrated), a second connector unit 61 and a third connector unit 69 that are connected to other main data buses, and a seventh connector unit 77 that is directly connected to a USB port on an I/O panel (not illustrated) on a rear portion of a computer or is connected to a USB connector (not illustrated) on a PCIe Add-in card for a USB signal interface provided in a PCIe slot are arranged side by side on a front portion of the SSD tripler 50.

The first to third storage media 59, 67, and 75 connected to the first to third connector units 51, 61, and 69 are coupled to connectors 57, 65, and 73 for storage media connection through bus switches 55, 63, and 71 provided therein along guides of bay supports 93-1 and 93-2.

FIG. 5 is a configuration diagram of SSD-based storage media and a PCIe-to-USB conversion M.2 card 100 and a PCIe Add-in card 110 for a password and a status information interface according to the related art. When the SSD-based storage media 1 and 50 according to the related art are used in a manner in which an authentication/unauthorized person is identified based on a password, in order to provide a simple installation environment and simply use the SSD-base storage media 1 and 50, an M.2 slot (not illustrated) on a motherboard provided inside the desktop PC is provided with the PCIe-to-USB conversion M.2 card 100.

A control unit 103 on the PCIe-to-USB conversion M.2 card 100 is connected to a PCIe edge-finger unit 101 via a PCIe bus, and one of USB connectors 105 and 107 connected to the PCIe-to-USB conversion control unit 103 is connected to the second connector unit 25 or the seventh connector unit 77 of the SSD-based storage media 1 and 5 according to the related art via a separate USB cable (not illustrated).

The PCIe Add-in card 110 is used for connection with external information devices used to provide a more convenient use environment by replacing a password that needs to be input every time a request for access to a storage media occurs using a fingerprint recognition mouse, a facial recognition camera, or a smartphone for facial recognition.

A series of USB connectors 117-1, 117-2, and 117-3 provided on a PCIe bracket of the PCIe Add-in card 110 may be divided into a USB connector 117-1 that is directly connected to a USB port provided on a I/O panel on a rear portion of a computer to transmit password data input by a user from a computer, a USB connector 117-3 to which an authorized/unauthorized signal output from one of external information devices 120, 150, and 170 is connected, the USB connector 117-2 that is branched off from the USB connector 117-3 input from an external information device to be connected to the computer, and a USB connector 115 that connects the USB connector 117-1 for user password data output from the computer and the USB connector 117-3 for authorized/unauthorized data output from the information device to the second connector unit 25 or the seventh connector unit 77 of the related art through a logic gate 113.

FIG. 6 illustrates application examples using a fingerprint recognition mouse 120, a facial recognition camera 150, or a smartphone 170 with a built-in facial recognition function such as external information devices 120, 150, and 170 that are coupled to the PCI Add-in card 100 of FIG. 5.

An output of identifying the authorized and unauthorized persons of these information devices 120, 150, and 170 is connected to a USB cable in the case of the fingerprint recognition mouse 120, a separate USB cable (not illustrated) connected to a USB connector 159 provided on a side of a support 157 in the case of the facial recognition camera 150, and the USB connector 117-3 for connection of the external information device provided on the PCIe Add-in card 110 of FIG. 5 through a separate USB cable connected to a USB connector 177 for a charging port provided at a lower end portion in the case of the smartphone 173 with a built-in facial recognition function.

As illustrated in FIG. 5, the output of the USB connector 117-3 connected to the information devices 120, 150, and 170 is connected to the USB connector 115 to which the SSD-based storage devices 1 and 50 of the related art is connected through the logic gate in addition to the USB connector 117-2 for signal bypass, and thus, when a user leaves his/her seat, the SSD-based storage device of the related art may turn an internal bus switch off to safely protect data from external intruders through a computer network.

### DISCLOSURE

### Technical Problem

The conventional solid state drive (SSD)-based storage media having a data protection function have a structure in which a first connector for a main data bus, which is connected to a computer, and a second connector, which is disposed at a position adjacent to the first connector to which the main data bus is connected in order to control a bus switch to which the main data bus is connected, are disposed in parallel.

Basically, based on permitting or blocking the access to the conventional SSD-based storage media having a data protection function by distinguishing the authorized person and the unauthorized person using various types of encryption systems that the connected computer system allocates in advance, the peripheral component interconnect express (PCIe) Add-in card type universal serial bus (USB) interface card needs to be installed in the PCI slot of the computer system in which the conventional SSD-based storage media having a data protection function are installed in order to transmit data recognized and identified by the fingerprint recognition mouse, the facial recognition camera, or the smartphone for facial recognition as the external information devices for distinguishing the authorized person and the unauthorized person into the computer through the USB port provided on the computer or the second connector.

The inconvenient and unnatural cable connection environment is caused by a situation in which in order to use the conventional SSD-based storage media having a data protection function even in the simple use environment by the password input manner that does not use the external information devices listed above, the second connector needs to be connected to the USB port protruding from the motherboard of the computer, and in order to connect the cable to the second connector of the conventional SSD-based storage media having a data protection function installed inside the desktop computer, and the cable needs to be connected to the second connector by passing the cable into the computer through the PCIe bracket hole on the I/O panel provided with the USB port.

In addition, since it is cumbersome to input a password to prove that a user is an authorized person every time data is transmitted, when the user uses an external information device, the external information device needs to transmit user identification result data to the second connector to protect data even when the user leaves a computer in use, and the identification result data of the authorized person and the unauthorized person needs to be transmitted to the second connector of the conventional SSD-based storage media having a data protection function even when not only the facial recognition camera for facial recognition or the smartphone for facial recognition but also the relatively simple fingerprint recognition mouse is used, so the PCIe Add-in card type USB interface card needs to be installed in the PCIe slot.

However, in the security function itself as well as the problems of the use environment listed above, even when the user leaves his/her seat in the environment in which the external information device is used, the external information devices listed above transmit the data identified to be unauthorized to the second connector to block the bus switch provided on the conventional SSD-based storage media having a data protection function, thereby maintaining a complete access blocking state, but there is a problem in that when the user works while sitting in front of the computer, the computer and the conventional SSD-based storage media having a data protection function are constantly connected to each other in a hardware manner through the USB port under the same computer environment, and as a result, there is always a possibility that the USB port is hacked by a hacker.

Meanwhile, the conventional SSD-based storage media having a data protection function performs the data protection function in a manner in which the bus switch is disconnected only by a special device such as the SSD doubler provided with the second connector only for the 2.5-inch SSD. However, by allowing the smartphone separate from the computer to access and block data while providing the simpler installation and use environment for storage means of various form factors such as a 3.5-inch hard disk drive (HDD), a 2.5-inch SSD and HDD, an M.2 SSD, and an M.3 SSD used independently on not only a desktop personal computer (PC) but also a notebook PC through a control means on the smartphone linked to a wireless communication module without installing the separate PCIe Add-in card type USB interface card and cables according thereto, the security environment is further improved than the conventional data access control method using the single computer system.

### Technical Solution

One aspect of the present invention provides a data storage means control apparatus having a data protection function by using wireless communication with a smartphone, the data storage means control apparatus including: a printed circuit board including one or more connection means exposed to the outside and a data storage means or a connection means connected to the data storage means; a first connector unit which is connected to a computer and to which a main data bus is connected among the connection means exposed to the outside; a data bus switch unit configured to connect the data bus to the first connector unit and the data storage means or disconnect the data bus therefrom; and a wireless communication unit connected to the smartphone of a user by a wireless interface and output an on/off control signal to the data bus switch unit according to a data access permission or blocking signal transmitted from the smartphone by the user, in which an access control function is performed for the data storage means in a manner in which an operation of connecting or disconnecting the main data bus is performed.

The data storage means may be an M.2 solid state drive (SSD), an M.3 SSD, a 2.5-inch SSD, a 3.5-inch SSD, and a peripheral component interconnect express (PCIe) Add-in card type SSD which are an independent type.

The data storage means may include an SSD controller and an arrangement form of nonvolatile memory devices.

The main data bus may be connected or disconnected to or from the SSD controller and the first connector unit or to or from the SSD controller and the arranged nonvolatile memory elements.

When a control unit for controlling redundant arrays of inexpensive disk (RAID) or a PCIe switch is further provided between the first connector unit and the connection means connected to the data storage means, a bus switch may further be provided between the first connector unit and the control unit, and the bus switch is turned on or off by an output signal of the wireless communication unit.

When a control unit for RAID control or PCI express switch control is further provided between the first connector unit and the connection means connected to the data storage means and the control unit is provided with an externally controlled main data bus enable pin, the control unit may connect the main data bus enable pin to the wireless communication unit so that the main data bus is connected or disconnected.

When a control unit for controlling RAID or a PCI express switch is further provided between the first connector unit and the connection means connected to the data storage means, a bus switch may further be provided between the connector unit and the connection means connected to the data storage means, and the bus switch may be turned on or off by an output signal of the wireless communication unit.

The wireless communication unit may communicate with the smartphone of the user by Bluetooth or Wi-Fi as a wireless interface.

The wireless communication unit may include an internal antenna when the data storage means control apparatus is installed in a 3.5-inch bay and include an external antenna provided at an outside of a PCIe bracket when the data storage means control apparatus is installed in a PCIe slot connector.

When the data storage means control apparatus is an SSD doubler or an SSD tripler installed in a 3.5-inch bay, the wireless communication unit or a wireless communication module constituting the wireless communication unit may be provided on a lower end surface of the printed circuit board.

The data storage means control apparatus may further include a protrusion preventing cover provided on a lower end surface of the data storage means control apparatus to prevent the protruding wireless communication unit or wireless communication module from protruding to the outside, in order that there is no protrusion outside the lower end surface of the data storage means control apparatus.

Another aspect of the present invention provides a data storage means control method of a data storage means control apparatus having a data protection function by using wireless communication with a smartphone, which includes performing an access control function for a data storage means in a manner in which an operation of connecting or disconnecting a main data bus is performed, wherein the data storage means control apparatus includes: a printed circuit board including one or more connection means exposed to the outside and the data storage means or a connection means connected to the data storage means; a first connector unit which is connected to a computer and to which the main data bus is connected among the connection means exposed to the outside; a data bus switch unit configured to connect the data bus to the first connector unit and the data storage means or disconnect the data bus therefrom; a wireless communication unit connected to a smartphone of a user by a wireless interface and output an on/off control signal to the data bus switch unit according to a data access permission or blocking signal transmitted from the smartphone by the user; and control software installed on the smartphone of the user to perform a configuration and/or control operation for the computer, the wireless communication unit, or the data bus switch unit.

The control software may set activation or deactivation of the wireless communication unit, and when the deactivation of the wireless communication unit is set, the bus switch constituting the data bus switch unit may be kept in an off state to block access from others.

The control software may transmit, to the computer, an on/off configuration signal of a virtual storage device for selecting whether the virtual storage device for the data storage means control apparatus is exposed on the computer to which the data storage means control apparatus is connected.

When the virtual storage device is configured to not be exposed, the configuration may be displayed on the computer in a detailed menu to allow the user to designate a Hot-Key for exposure, and when the virtual storage device is exposed on the computer but only a search window corresponding to the virtual storage device is not exposed, an open confirmation button of the search window may pop up on a screen of the smartphone of the user in a state in which the virtual storage device is double-clicked to allow the user to press the confirmation button so as to open the search window.

When an access operation for the data storage means control apparatus is generated on the computer, the control software may control the data bus switch unit to be kept in an on or off state by allowing the user to operate the smartphone according to a preset operation start security configuration.

The control software may determine whether to perform the access operation for the storage device by a simple touch on a display screen and at least one recognition means among recognition means using biometric recognition including palm recognition, fingerprint recognition, and facial recognition according to a security configuration of the user, as the operation start security configuration.

The control software may block an operation by a preset timer value after the access operation for the data storage means control apparatus proceeds by a manipulation of the user according to the operation start security configuration.

The timer value may be updated to a value generated by a time required to transmit a file from the computer.

The control software may switch the data bus switch unit to the on state by the manipulation of the user according to the operation start security configuration so that the access operation for the data storage means control apparatus proceeds, and after the access operation is completed, may receive an access operation complete bit transmitted through an interface connector connected to the computer by a wire or wireless interface means provided on the computer to switch the data bus switch unit to the off state.

The access operation complete bit may be generated according to the time required to transmit the file from the computer or in association with a file handle according to the transmission of the file.

The control software may receive information on the access to the data storage means control apparatus transmitted from the computer to which the data storage means control apparatus is connected through a wireless interface means provided on the computer to select whether to perform access control only for a read operation, access control only for a write operation, or access control for both the read operation and the write operation.

When communication with the data storage means control apparatus may approach a state where communication is not performable, the control software may store various types of preset configuration information in an arbitrary register and then switch both access setting values for a read operation and a write operation to an access blocking state, and when the communication with the data storage means control apparatus becomes smooth, the control software may restore the configured access control information from the stored arbitrary register and switch the restored access control information to an original state.

### Advantageous Effects

In the case of a solid state drive (SSD)-based storage media having a data protection function of the related art, even though an external information device is used as a security means under a single computer environment, when a user leaves his/her seat, a bus switch inside the SSD-based storage media is turned off, so the security is reliably ensured, but when the user is performing work in front of a computer, there is a possibility that a universal serial bus (USB) port of the computer may be hacked since the computer and the SSD-based storage media of the related art are kept connected via the USB.

However, according to a data storage means control apparatus and method having a data protection function by using wireless communication with a smartphone according to the present invention, the data storage means control apparatus of the present invention provides a software control method that operates in a manner of permitting or blocking access by a smartphone of a user as a completely separate external information device from the viewpoint of a computer and network in which the data storage means control apparatus is installed, thereby providing the high-level security for the data storage means and making product installation simple without a separate USB interface card or USB cable which was required in the related art.

The present invention provides a disk security level similar to enhancing security through an additional personal authentication procedure by inputting numbers through an automatic response system (ARS) or text through a social networking service (SNS) with the smartphone of the user as a heterogeneous information device that is separated from the network in addition to using a public certificate or a transfer password on the computer in the case of remittance of a large amount of more than a certain amount set in advance like an Internet banking environment operating in a high-level security environment.

The effects of the present invention are not limited to the above-described effects. That is, other effects that are not described may be obviously understood by those skilled in the art from the claims.

### DESCRIPTION OF DRAWINGS

FIG. 1 is a block configuration diagram of a solid state drive (SSD) doubler including a connector unit for one main interface and a connector unit for an encryption and status information interface according to the related art.

FIG. 2 is a block configuration diagram of an SSD tripler including a connector unit for a plurality of main interfaces and a connector unit for an encryption and status information interface according to the related art.

FIG. 3 shows a perspective view and a front view of the SSD doubler according to the related art.

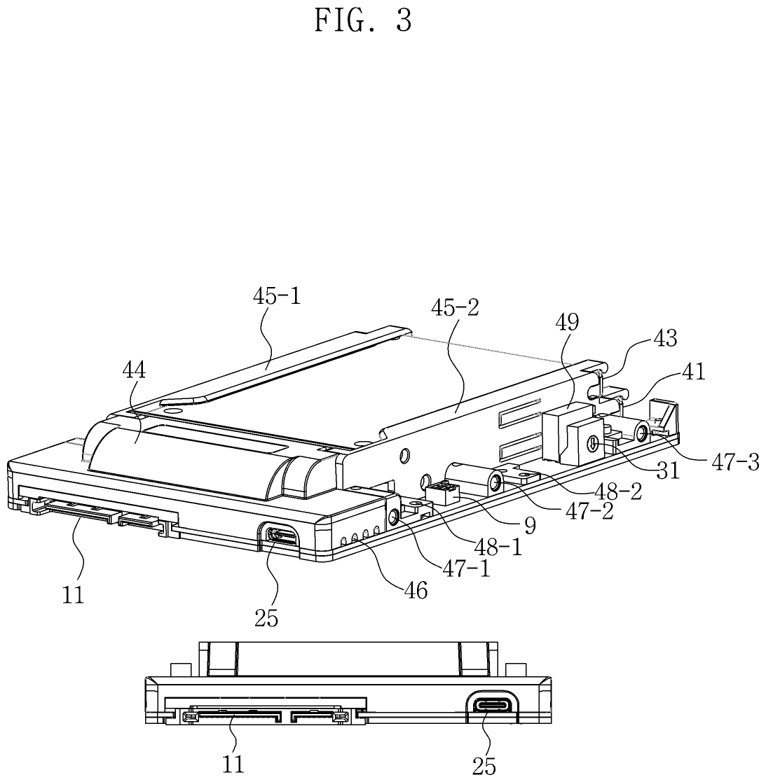

FIG. 4 shows a perspective view and a front view of the SSD tripler according to the related art.

FIG. 5 is a configuration diagram of an SSD-based storage medium and a peripheral component interconnect express (PCIe) to universal serial bus (USB) conversion M.2 card for an encryption and status information interface according to the related art and a PCIe Add-in card for connection with an external information device.

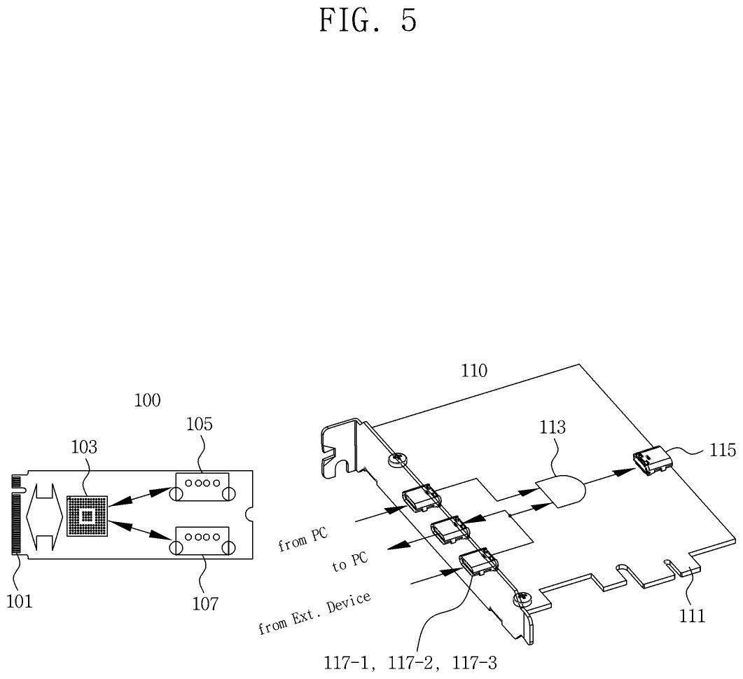

FIG. 6 is a diagram schematically illustrating the use of a mouse, a personal computer (PC) camera, and a smartphone with a built-in fingerprint recognition sensor as a biometric recognition means, as an external information device according to an embodiment of the related art.

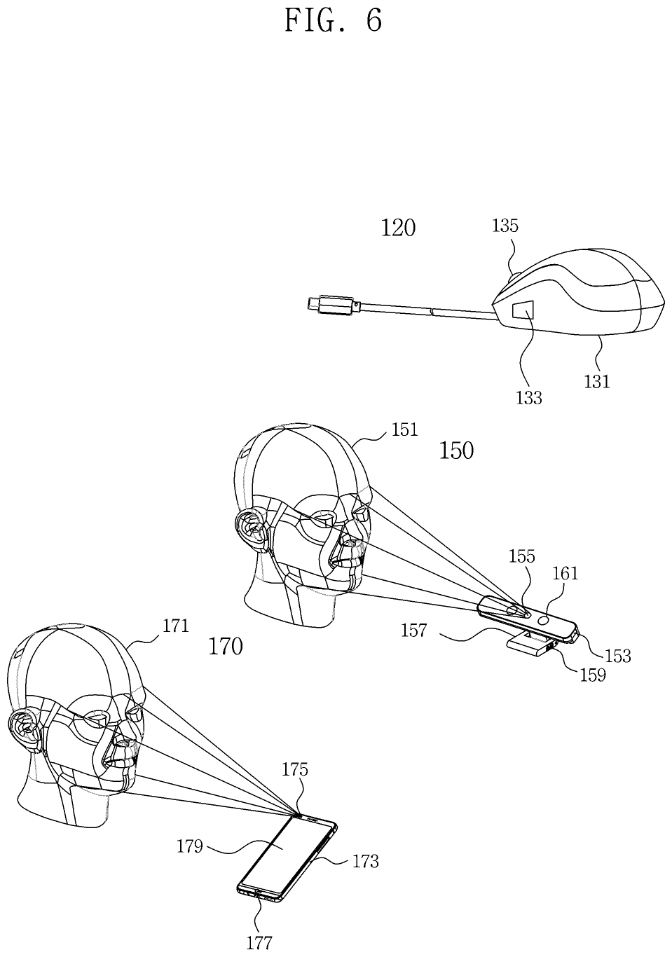

FIG. 7 is a block configuration diagram of an SSD doubler including a connector unit for one main interface provided with a wireless communication unit to control a bus switch according to the present invention.

FIG. 8 is a block configuration diagram of a PCIe Add-in card type storage device including a wireless communication unit according to the present invention.

FIG. 9 shows a perspective view and a front view of the SSD doubler according to the present invention and a rear perspective view of the SSD doubler provided with a wireless communication module.

FIG. 10 is a configuration diagram of a PCIe Add-in card provided with a wireless communication unit to control a bus switch according to the present invention.

FIG. 11 is a configuration diagram of a dongle provided with a wireless communication unit to control a bus switch according to the present invention.

FIG. 12 is a configuration diagram of a 2.5-inch SSD-based storage device in the PCIe Add-in card type which is provided with a wireless communication unit to control a bus switch according to the present invention.

FIG. 13 is a diagram of a smartphone equipped with software for controlling a storage device according to the present invention.

FIG. 14 is a diagram illustrating a smartphone having a configuration according to the software for controlling a storage device according to the embodiment of the present invention.

### BEST MODE

Various advantages and features of the present invention and methods of accomplishing them will become apparent from the following description of embodiments with reference to the accompanying drawings. However, the technical idea of the present invention is not limited to the embodiments to be described below, but may be implemented in various different forms, these embodiments will be provided only in order to make the present invention complete and allow those skilled in the art to completely recognize the scope of the present invention, and the embodiments of the technical idea of the present invention will be defined by the scope of the claims.

Terms used in the present specification are for describing exemplary embodiments rather than limiting the present invention. Unless otherwise stated, a singular form includes a plural form in the present specification.

It should be further understood that terms “include” and “have” used in the present specification specify the presence of features, numerals, steps, operations, components, parts mentioned in the present specification, or combinations thereof, but do not preclude the presence or addition of one or more other features, numerals, steps, operations, components, parts, or combinations thereof.

Further, the embodiments described in the specification will be described with reference to cross-sectional views and/or plan views that are ideal exemplary views. Therefore, the embodiments of the present invention are not limited to specific forms illustrated, but may include the change in forms if necessary. For example, a region shown at a right angle may be rounded or may have a predetermined curvature. Accordingly, areas illustrated in the drawings have schematic attributes, and shapes of the areas illustrated in the drawings are for exemplifying a specific shape of an area of the device and are not intended to limit the scope of the invention.

Throughout the specification, like reference numerals denote like elements. Accordingly, the same reference numerals or similar reference numerals may be described with reference to other drawings, even when not mentioned or described in the corresponding drawings. Further, even when reference numerals are not indicated, they may be described with reference to other drawings.

Hereinafter, a data storage means control apparatus and method having a data protection function through wireless communication with a smartphone according to exemplary embodiments of the present invention will be described in detail with reference to the accompanying drawings.

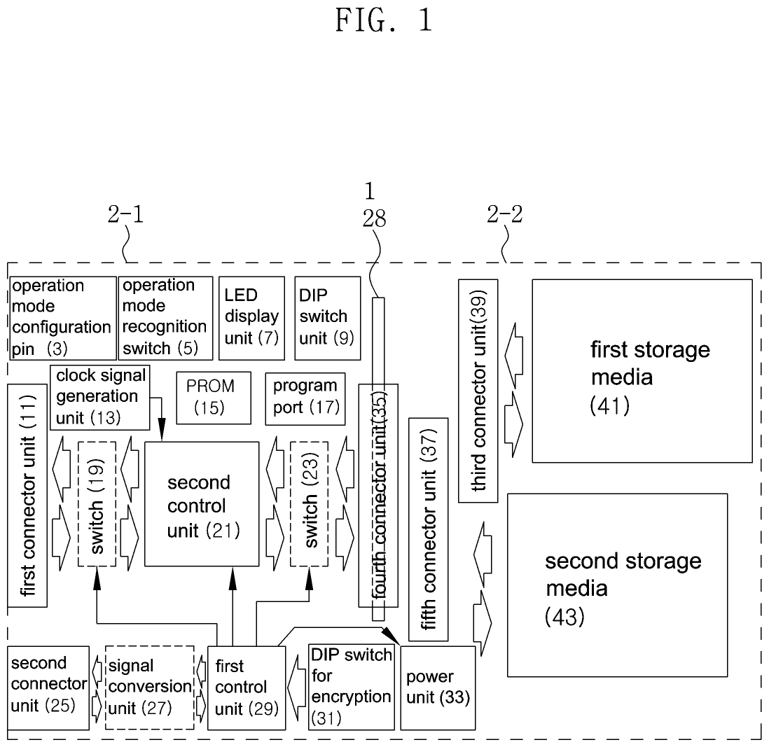

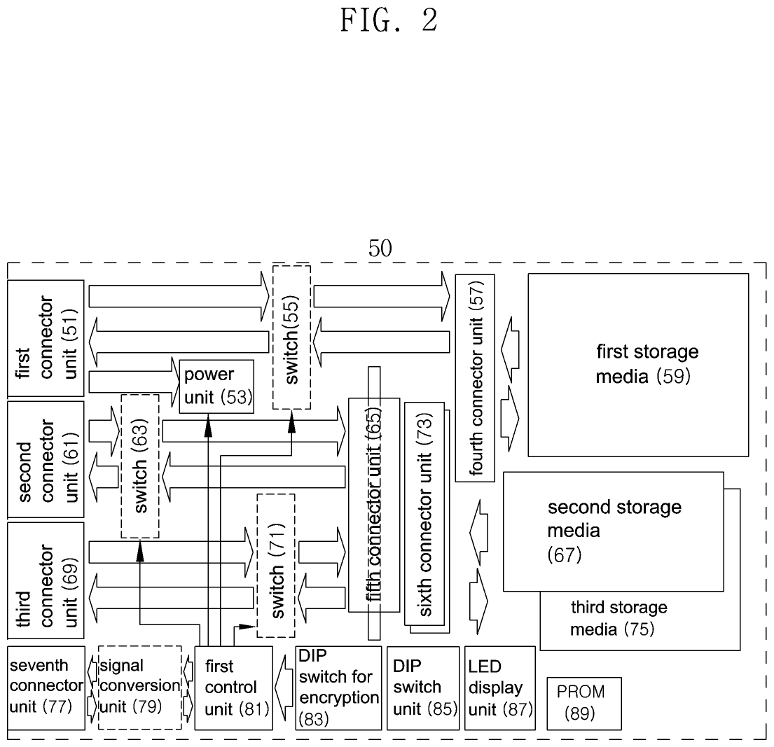

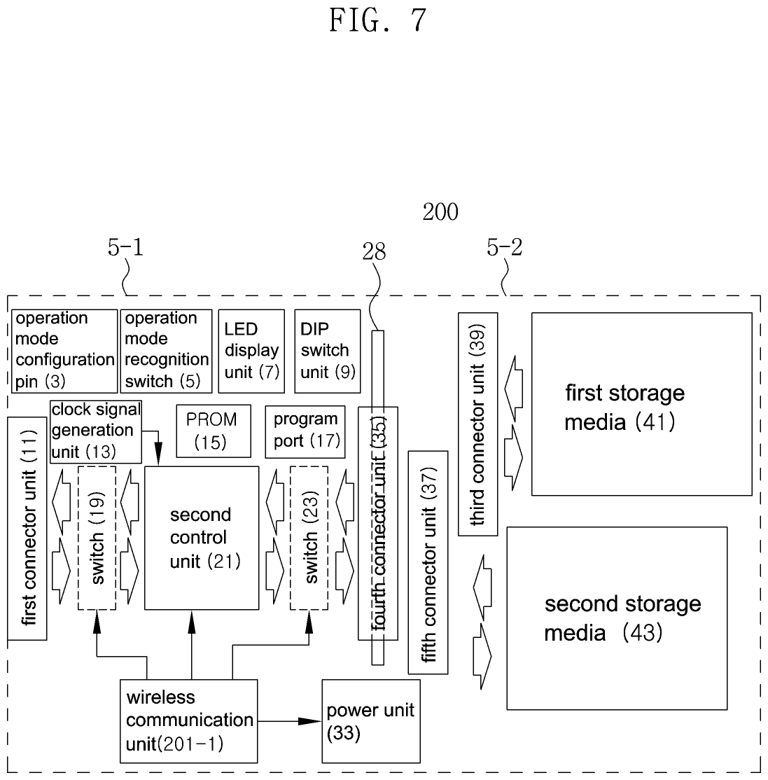

FIG. 7 is a block diagram of a solid state drive (SSD) doubler 200 including a connector unit for one main data bus which is provided with a wireless communication unit to control a bus switch according to the present invention, and connecting or disconnecting a main data bus between a first connector unit 11 and a control unit 21 by controlling a bus switch 19 is basically the same as the related art, but second connector units 25 and 77, signal conversion units 27 and 79, first control units 29 and 81, and dual in-line package (DIP) switches 31 and 83 for encryption illustrated in FIGS. 1 and 2 of the related art are replaced with a wireless communication unit 201-1.

The wireless communication unit 201-1 is connected to a smartphone 400 of a user by a Bluetooth or Wi-Fi interface standard and is connected to an on/off control pin of the bus switch 19 connected to an arbitrary output pin of the wireless communication unit 201-1 according to a control signal transmitted from the smartphone 400 of the user.

When the first connector unit 11 and the control unit 21 are connected to each other by the main data bus or a bus switch 23 is provided between the control unit 21 and a first storage media 41 and a second storage media 43, access control for the first storage media 41 and the second storage media 43 is performed by a bus switch on/off output signal of the wireless communication unit 201-1.

Preferably, instead of using the separate bus switches 19 and 23, the control unit 21 itself may include a main data bus enable pin (not illustrated) for turning on/off the main data bus on the first connector unit 11 or turning on/off the main data bus on the first storage media 41 and the second storage media 43 to perform the access control.

In addition to a method of connecting or disconnecting the main data bus by the main data bus enable pin of the bus switches 19 and 23 or the control unit 21, an effect of connecting or disconnecting the main data bus by a method of turning on/off a specific power unit for applying power to the first storage media 41, the second storage media 43, or the control unit 21 among power units 33 separately provided for each configuration block may be substituted.

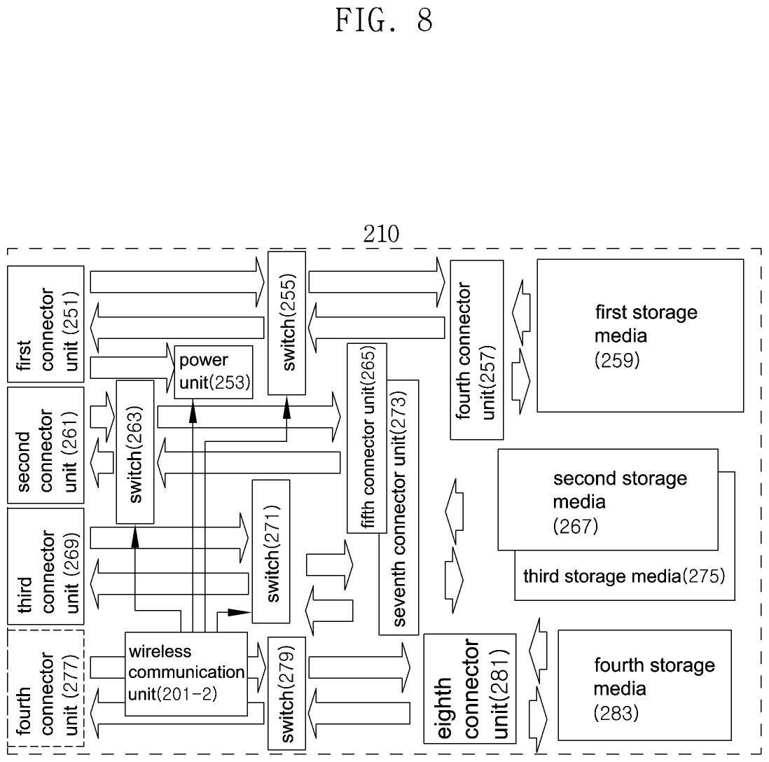

FIG. 8 is a block configuration diagram 210 of a peripheral component interconnect express (PCIe) Add-in card type storage device 350 including a wireless communication unit 201-2 according to the present invention, which has a configuration similar to a configuration in which a seventh connector unit 77, a signal conversion unit 79, a first control unit 81, and a DIP switch for encryption 83 of the SSD tripler 50 provided in FIG. 2 according to the related art are replaced with the wireless communication unit 201-2.

Referring in detail to the configuration of FIG. 8, when connector units 251, 261, 269, and 277 for a main data bus connected to the computer are connected to first to fourth storage media 259, 267, 275, and 283 by the main data bus, the connector units 251, 261, 269, and 277 for a main data bus connected to the computer are connected to the first to fourth storage media 259, 267, 275, and 283 through fifth to eighth connector units 257, 265, 273, and 281 that connect bus switches 255, 263, 271, and 279 corresponding to each storage medium to the storage media 259, 267, 275, and 283, and each of the bus switches 255, 263, 271, and 279 are independently connected to an output pin of the wireless communication unit 201-2 to perform the turn on/off operation, thereby performing an access control operation for the first to fourth storage media 259, 267, 275, and 283.

The PCIe add-in card type storage device 350 including the wireless communication unit 201-2 of FIG. 8, compared to the structure in FIG. 7 in which the first connector unit 11 is connected to the storage media 41 and 43 with the control unit 21 interposed therebetween, has a structure in which when the first to fourth connector units 251, 261, 269, and 277 connected to the computer are each connected to the first to fourth storage media 259, 267, 275, and 283 by the independent main data bus without a separate control unit interposed therebetween, the first to fourth connector units 251, 261, 269, and 277 are connected to the first to fourth storage media 259, 267, 275, and 283 with the bus switches 255, 263, 271, and 279 interposed therebetween, respectively.

In the structure of the PCIe Add-in card type storage device 210 including the wireless communication unit 201-2 of FIG. 8, the access control operation is performed for the first to fourth storage media 259, 267, 275, and 283 by independently controlling each of the bus switches 255, 263, 271, and 279 according to control of smartphone software 500 for controlling a storage device installed in the smartphone 400 of the user.

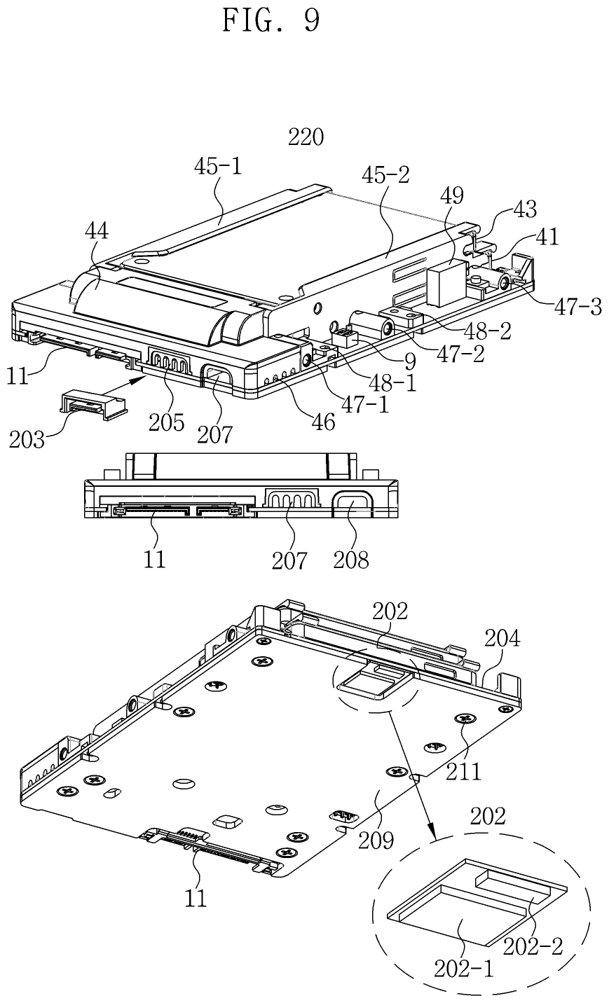

FIG. 9 illustrates a perspective view, a front view, and a rear perspective view of an SSD doubler 220 including the wireless communication unit 201-1 according to the present invention.

The SSD doubler 220 including the wireless communication unit 201-1 of FIG. 9 implements the block diagram illustrated in FIG. 7 as a storage device according to an embodiment, and a front portion thereof is provided with the first connector unit 11 to which a power unit and the main data bus are connected, a heat dissipation cover 205 for replacing a serial advanced technology attachment (SATA) 7 pin connector 203, and a heat dissipation hole 207.

The heat dissipation cover 205 on the front portion of the SSD doubler 220 including the wireless communication unit 201-1 of FIG. 9 may be used to increase a width of an interface lane of the main data bus connected to the first connector unit 11 and may be replaced with a connector (not illustrated) such as OCULINK when the main data bus is extended from PCIe x4 to PCIe x8.

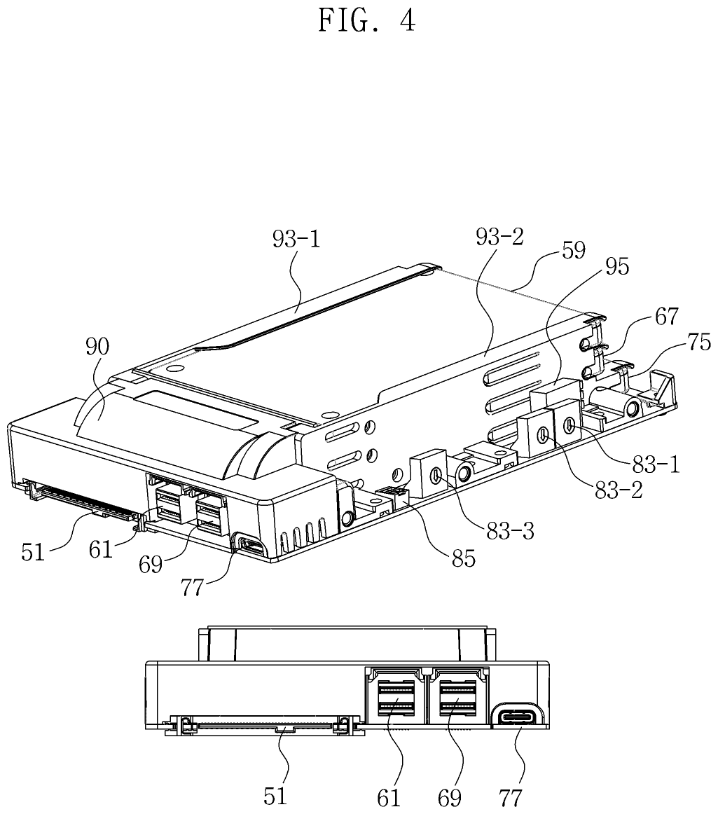

The control unit 21 is removed, the first storage media 41 is connected to the first connector unit 11, and the second storage media 43 is connected to the SATA 7 pin connector 203 replacing the heat dissipation cover 205, and as a result, it is possible to constitute the reduced form of FIG. 4.

In the related art, the second connector unit 25 illustrated in FIG. 1 or the seventh connector unit 77 illustrated in FIG. 4 of the related art, in which the control signal for the bus switch 19 is input by being connected to the universal serial bus (USB) connector of the computer, configures the heat dissipation hole 207 in a state in which the USB connector is removed.

As an embodiment of configuring the wireless communication unit 201-1 according to the present invention, the wireless communication module 202 is provided on a lower end surface of a printed circuit board 204 into which the first storage media 41 is inserted.

Such a part may be positioned at a position farthest from a lower end portion of a heat dissipation cover 44 with relatively high noise from a digital circuit due to electronic components in which main core configuration blocks including the control unit 21 constituting the SSD doubler 200 including the wireless communication unit 201-1 of the present invention are densely located, and may be positioned at a position farthest from a position where a radio frequency (RF) configuration unit including a wire type antenna (not illustrated) or a chip type antenna 202-2 of the wireless communication module 202 when mounted in the computer may be least affected by the noise from the digital circuit and a position where there is no noise generation source therearound.

Like a typical 3.5-inch hard disk drive or 2.5-inch SSD, the data storage means control apparatus 220 having a data protection function of the present invention needs to be installed on a flat floor, and therefore, in the present invention, as illustrated in FIG. 9, a wireless communication module protrusion preventing cover 209 is provided to prevent the wireless communication unit 201-1 or the wireless communication module 202 constituting the same from protruding to the outside of the wireless communication module protrusion preventing cover 209.

As illustrated in FIG. 9, the wireless communication module protrusion preventing cover 209 has a shape cut into a ‘U’-shaped opening hole for the interior view, but preferably only the antenna 202-2 portion that should protrude to the outside is exposed, and a wireless communication controller 202-1 and devices (not illustrated) therearound may serve as a shield cover against radiated noise generated from the wireless communication controller 202-1 and the devices therearound by performing surface-down processing on the wireless communication module protrusion preventing cover 209.

The wireless communication module protrusion preventing cover 209 serves to not only prevent the wireless communication unit 201-1 or the wireless communication module 202 constituting the same from protruding, but also to prevent various components (not illustrated) to be provided at a lower end of the printed circuit board 204 as the device around the control unit 21 and pins of an LED module 49 constituting an LED display unit 7 from protruding to the outside of the wireless communication module protrusion preventing cover 209.

The wireless communication module protrusion preventing cover 209 is securely inserted into the fixing holes provided at lower ends of the bay supports 45-1 and 45-2 through a fixing means 211 such as a screw bolt with the printed circuit board 104 interposed therebetween.

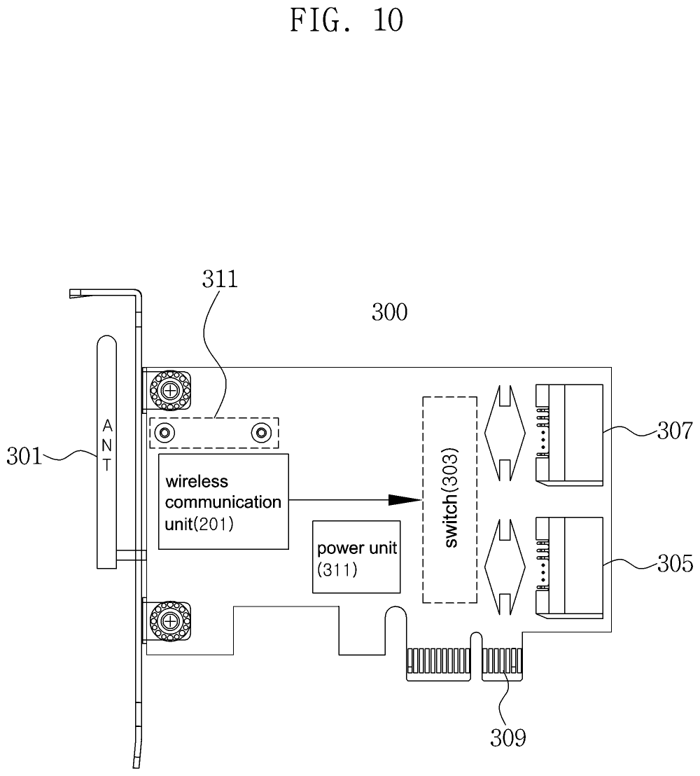

FIG. 10 illustrates a PCIe Add-in card 300 provided with the wireless communication unit 201 to control a bus switch 303 according to the present invention, and the wireless communication unit 201 protrudes to the outside of the PCIe bracket to be connected to the provided antenna 301 and the printed circuit board by wiring and controls an on/off operation of the bus switch 303 according to an access control signal received from the smartphone 400 of the user.

The bus switch 303 is provided on a main data bus between a host computer-side connector 305 for SATA or non-volatile memory express (NVMe) (here, Express refers to a PCIe interface) connected to a computer and a storage media-side connector 307 for SATA or NVMe connecting between storage media (not illustrated).

When the storage media connected to the storage media-side connector 307 for SATA or NVMe is a SATA 3.5-inch hard disk drive or a 2.5-inch SSD, the storage media-side connector 307 for SATA or NVMe is provided as a connector for SATA 7 pin or NVMe corresponding to external storage media, and when the storage media connected to the storage media-side connector 307 for SATA or NVMe is an M.2 SSD or M.3 SSD, the storage media-side connector 307 for SATA or NVMe is provided as a connector corresponding to each storage medium in a manner that is provided as the connector corresponding to the M.2 SSD or M.3 SSD.

When the M.2 SSD or M.3 SSD is used, the M.2 SSD or M.3 SSD is fixed to an M.2 SSD or M.3 SSD memory card fixing hole 311 provided in accordance with a length of the installed M.2 SSD or M.3 SSD by using a fixing means (not illustrated) such as the screw bolt.

A PCIe Edge-Finger unit 309 supplies main power to a power unit 311, and supplies power output from the power unit 311 to the wireless communication unit 201 and the bus switch 303.

A PCIe main data bus of the PCIe Edge-Finger unit 309 is connected to NVMe interface pins of the host computer-side connector 305 for SATA or NVMe when the storage media used are storage media supporting the PCIe interface.

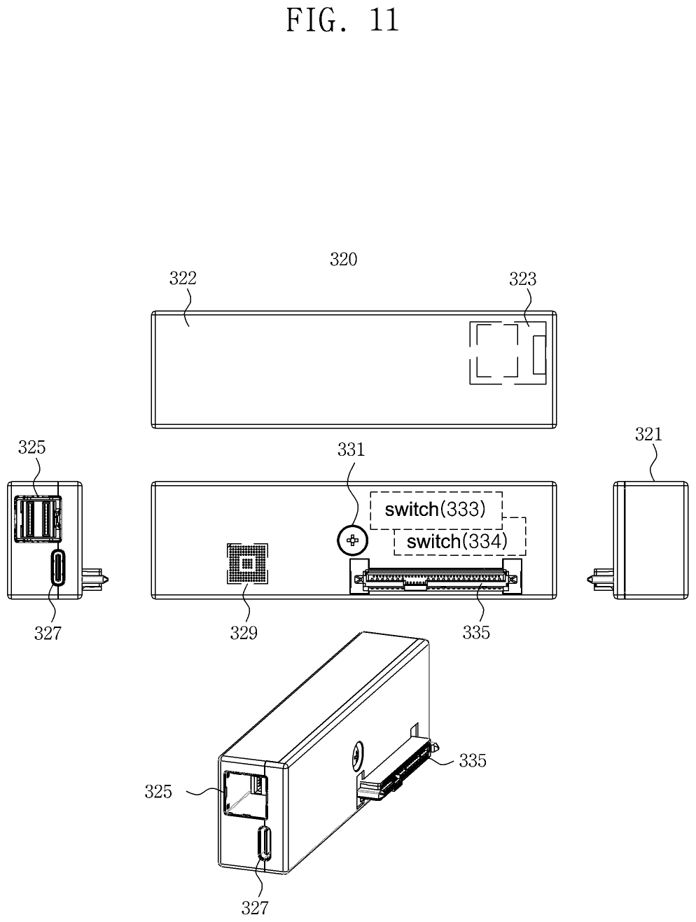

FIG. 11 is a diagram illustrating a dongle 320 provided with a wireless communication module 323 to control the bus switch 23 according to the present invention, which is used for data access control by being coupled to a 3.5-inch hard disk drive, a 2.5-inch SSD, or other SSD enclosure products in a notebook personal computer (PC) use environment.

The configuration of the dongle 320 will be described in more detail as follows.

The dongle 320 is formed in an external view thereof by fixing a dongle cover 322 to a dongle body 321 with a dongle cover fixing bolt 331, and the following components are formed to have an electrical circuit-like connection relationship in an internal view thereof.

An NVMe or SATA interface port 325 for an external interface is connected to a PCIe port provided on the computer with a separate NVMe interface cable (not illustrated), and a main data bus of PCIe is connected to a bus switch 333.

The bus switch 333 connects the other main data buses to PCIe interface pins provided in an SFF-3639 connector 335.

Meanwhile, the bus switch 333 is connected to a bus switch on/off control pin of the wireless communication module 323 to perform an access control operation for NVMe interface type storage media (not illustrated) connected to an SFF-8639 connector 335 according to the control signal of the smartphone software 500 for controlling a storage device provided on the smartphone 400 of the user.

A USB interface port 327 for an external interface is connected to a USB-to-SATA conversion controller 329, and the main data bus of the SATA interface converted through the USB-to-SATA conversion controller 329 is connected to a bus switch 334, which is controlled to be turned on/off by the bus switch control pin of the wireless communication module 323, to be connected to SATA interface pins provided at a lower end of the SFF-8639 connector 335.

The power pins provided at the lower end of the SFF-8639 connector 335 are connected to the power pins provided on the USB interface port 327, and when an additional power unit is required, an empty space provided on the left side of the USB interface port 327 may be supplemented by providing a separate input power connector.

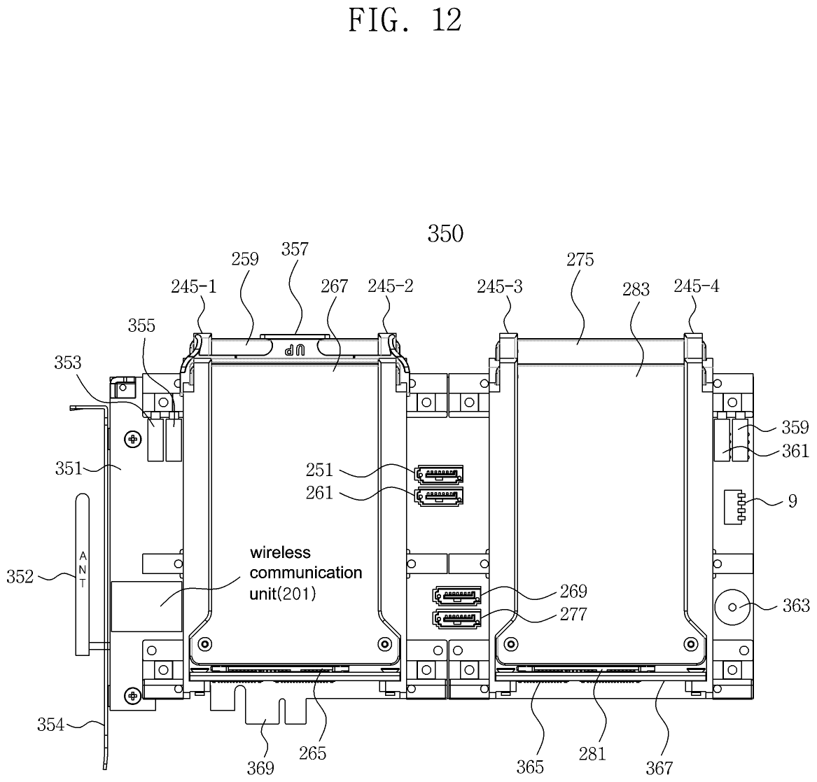

FIG. 12 illustrates a PCIe Add-in card type 2.5-inch SSD-based storage device 350 provided with the wireless communication unit 201 to control a bus switch (not illustrated) according to the present invention, and main components thereof are as follows.

A PCIe Bracket 354 coupled to a printed circuit board 351 of the PCIe Add-in card equipped with the wireless communication unit 201, and an antenna 352 protruding to an outside of the PCIe bracket 354 is connected to the wireless communication unit 201 in a circuit manner through wiring on the printed circuit board 351.

Four bay supports 245-1, 245-2, 245-3, and 245-4 are disposed on an upper end of the printed circuit board 351 of the PCIe Add-in card to accommodate four 2.5-inch SSDs and are coupled to a lower end portion of the printed circuit board 351 using a separate fixing means (not illustrated).

First to fourth storage media 259, 267, 275, and 283 are mounted in a structure in which the first to fourth storage media 259, 267, 275, and 283 are stacked in two stages in a sliding manner in the four 2.5-inch bays formed by the arrangement of the bay supports 245, and the second storage media 267 and the fourth storage media 483 mounted in the two upper bays are each connected to a vertical connection board 367 coupled to a vertical connection board connector 365 provided at a lower end through a sixth connector unit 265 and an eighth connection unit 281 provided at an upper end of the vertical connection board.

That is, the PCIe Add-in card type 2.5-inch SSD-based storage device 350 provided with the wireless communication unit 201 to control bus switches 255, 263, 271, and 279 according to the present invention of FIG. 12 has a structure in which as illustrated in the block configuration diagram 210 of FIG. 8, the first to fourth connector units 251, 261, 269, and 277 connect a main data bus in a circuit manner through the fifth to eighth connector units 257, 265, 273, and 281, to which the first to fourth storage media 259, 267, 275, and 283 are connected, by using the bus switches 255, 263, 271, and 279 provided on the printed circuit board 351.

As other peripheral devices, activity LED modules 353 and 359 and fault LED modules 355 and 361 are provided outside left/right bay supports 245-1 and 245-4 as an LED display means for monitoring the operation state of the mounted SSD.

When an error occurs on any storage media during use, a storage media removal handle 357 moves on the storage media corresponding to a position of a red LED displayed on the fault LED modules 355 and 361, thereby easily removing the storage media with errors.

Although it is assumed that the configuration of FIG. 12 described above is a structure in which as illustrated in FIG. 8, independent first to fourth connector units 251, 261, 269, and 277 are each connected to a motherboard (not illustrated) provided on a computer by independent data buses, it can be a structure in which after the control unit 21 is provided as illustrated in FIG. 7, in the same structure as the first connector unit 11 is connected to the control unit 21, and as in the configuration of FIG. 12, the number of storage media connected to the control unit 21 is expanded to four.

In this case, the first connector unit 11 may be replaced with a PCIe edge-finger unit 369, and preferably, in consideration of the number of extended storage media, it is reasonable that the PCIe edge-finger unit 369 is provided as a more extended PCIe edge-finger unit 369 considering the main data bus lane of the control unit 21 as well.

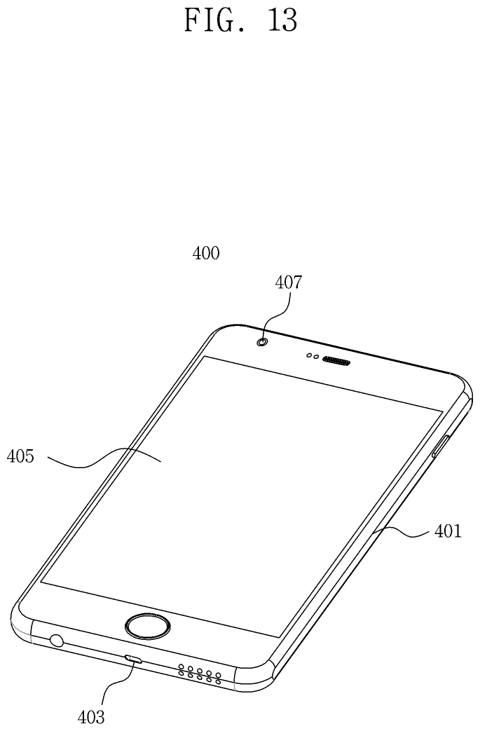

FIG. 13 illustrates the smartphone 400 equipped with the smartphone software 500 for controlling a storage device according to the present invention, in which a smartphone body 401 is provided with a display 405 on which various detailed menus displayed based on a graphic user interface are displayed, an upper end of a front portion of the smartphone body 401 is provided with a front camera 407 for facial recognition, a lower end of the front portion thereof is provided with a connector 403 for combined use as a charging terminal and an USB interface, and the smartphone body 401 is connected to a computer by a USB cable (not illustrated) to form the interface environment with the computer along with the charging.

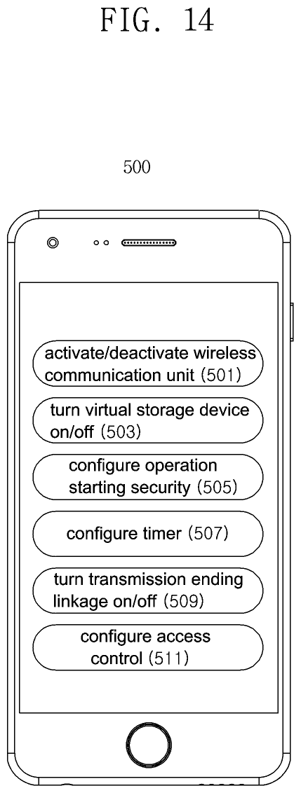

FIG. 14 illustrates the smartphone 400 illustrating the configuration of the smartphone software 500 for controlling a storage device according to the embodiment of the present invention, and a detailed configuration thereof is as follows.

A wireless communication unit activation/deactivation control tab 501 artificially activates or deactivates the wireless communication unit 201 provided in the data storage means control apparatus having a data protection function by using wireless communication with a smartphone according to the present invention.

As an example, when the wireless communication unit provided in the data storage means control apparatuses 200, 210, 300, and 320 according to the present invention is a Bluetooth module and when the wireless communication unit activation/deactivation control tab 501 is in an activated state, a user performs a pairing operation when he/she stands in front of a computer on which the data storage means control apparatuses 200, 210, 300, and 320 according to the present invention are installed to keep the data storage means control apparatuses 200, 210, 300, and 320 according to the present invention in a usable state, and when the wireless communication unit activation/deactivation control tab 501 is in a deactivated state, the wireless communication unit 201 is kept in an unused state so that the bus switch or bus switches connected thereto are kept in an off state.

### MODES OF THE INVENTION

The contents that a virtual storage device on/off control tab 503 detects the data storage means control apparatuses 200, 210, 300, and 320 in the process of booting the computer (not illustrated) in which the data storage means control apparatuses 200, 210, 300, and 320 according to the present invention are installed, copies disk attribute information read from the data storage means control apparatuses 200, 210, 300, and 320 to an arbitrary area on a main memory (not illustrated) on the computer, generates a virtual storage device, and keeps a bus switch in an off state have already been described in the related art, but there is a problem that the contents are exposed at all times by starting a search window for the virtual storage device.

In order to solve this problem, in the present invention, the virtual storage device on/off control tab 503 is provided on the smartphone of the user, and when the virtual storage device is set to be in an on state, as in the related art, a search window is started in a manner in which the virtual storage device is exposed at all times and a user double-clicks the virtual storage device with a mouse, so the user is permitted to view various disks and internal file information of the data storage means control apparatuses 200, 210, 300, and 320 according to the present invention.

When the virtual storage device is set to be in an off state and when the virtual storage device is set to not be exposed according to setting of a sub-menu configuration of the virtual storage device on/off control tab 503, a Hot-Key exposing the virtual storage device is designated on the keyboard connected to the computer, and thus, the virtual storage device is exposed by pressing the Hot-Key when a user tries to access the data storage means control apparatuses 200, 210, 300, and 320 according to the present invention at any time.

In addition, when the virtual storage device is set to be in the off state, the virtual storage device is exposed only with a disk name such as D: or E: in the submenu configuration of the virtual storage device on/off control tab 503, but the search window may be set not to start even when the user double-clicks the exposed virtual storage device with the mouse.

In this case, when the virtual storage device detects a double-clicked state, a pop-up window that confirms an opening of the search window for the virtual storage device is displayed on the screen of the smartphone of the user according to the state display information transmitted by the wireless interface method from the connector 403 for combined use as a charging terminal and an USB interface of the smartphone 400 from the computer or the wireless interface dongle (not illustrated) installed on the USB port provided on the rear input/output (I/O) panel of the computer, and thus the search window is opened when the user presses a confirmation button.

The case where the pop-up window notifying the opening of the search window on the screen of the smartphone of the user is opened even though the user does not double-click the virtual storage device is regarded as an access attempt by a third party, so the user may directly monitor the access attempt and the data storage means control apparatuses 200, 210, 300, and 320 may be kept in an access blocking state.

When a user starts an access operation to the data storage means control apparatuses 200, 210, 300, and 320 according to the present invention on a computer and when the access operation start information is received by the wireless interface method from the connector 403 for combined use as a charging terminal and an USB interface of the smartphone 400 of the user connected to the computer or the wireless interface dongle (not illustrated) installed on the USB port provided on the rear I/O panel of the compute, an operation start security configuration control tab 505 induces the smartphone software 500 for controlling a storage device of the present invention to confirm whether the user is an authorized/unauthorized person according to the configured state of the preset operation start security configuration control tab 505, transmits an access permission signal to the wireless communication unit 201 provided in the data storage means control apparatuses 200, 210, 300, and 320 according to the present invention only when it is confirmed that the user is the authorized person, and then switches the bus switch connected to the wireless communication unit 201 to the on state so that the access operation of the user may be permitted.

The details of the operation start security configuration control tab 505 will be described below.

A method of initiating an operation by simply touching a display, which is mainly used when the computer is used only by the user without requiring insider security for other internal users, is a user authorization method for initiating an operation most quickly and simply by focusing on the fact that a hacker who intrudes through a computer network cannot touch the display of the user's smartphone as a heterogeneous information device separated from the computer system.

A method of initiating operation using an unlock password of a smartphone is a method of determining whether a user is an authorized person by inputting a rubber band, fingerprint recognition, or a character corresponding to a user password as an operation starting means.

A method of starting an operation by palm recognition is a method of applying biometric recognition security to the quick and simple user authorization method by the simple touch in the above (1) as an operation starting means.

A method of starting an operation by facial recognition using the front camera 407 of the smartphone 400 only includes putting the smartphone 400 of the user in an appropriate position at a lower end of the monitor when the user's face recognition processing is quickly performed according to the operation performance of the smartphone 400, thereby providing an environment in which the data storage means control apparatuses 200, 210, 300, and 320 according to the present invention may be used under a secure environment even under the environment where the computer is used naturally without the separate display touch operation as in (1), (2) or (3) above.

In the above, the details of the operation start security configuration control tab 505 have been described, but in actual operation, the operation start security configuration control tab may be conveniently used as a single item of operation start security configuration, or may be used in a more enhanced secure state with an operation start security configuration of multiple items, according to the user's configuration state.

A timer configuration control tab 507 is used for the purpose of maintaining the data storage means control apparatuses 200, 210, 300, and 320 in an access permission state only for a preset time period when the operation is started by the operation start security configuration control tab 505.

For example, when the user sets the timer value to 30 seconds in the timer configuration control tab 507, the transmission of files transmitted within 30 seconds after the start of the operation are completed, but files that are attempted to be transmitted after 30 seconds pass are not transmitted.

For another purpose of the timer configuration control tab 507, when a specific period is set and the data storage means control apparatuses 200, 210, 300, and 320 according to the present invention are set for 24 hours by the timer configuration control tab 507, users who access the computer may access the data storage means control apparatuses 200, 210, 300, and 320 according to the present invention only for the corresponding 24 hours on the set date.

The timer configuration control tab 507 may receive information on the time required to transmit a file by a wireless interface method from the connector 403 for combined use as a charging terminal and an USB interface of the smartphone 400 from the computer or the wireless interface dongle (not illustrated) installed on the USB port provided on the rear I/O panel of the computer before/after the file is transmitted while starting the operation by the operation start security configuration control tab 505 according to the configuration of the detailed menu item, and replace the time with the set timer value, thereby keeping the access state to the data storage means control apparatuses 200, 201, 300, and 302 according to the present invention in the access blocking state while completing the transmission of the file.

Unlike the method of updating the timer setting value by receiving the information on the time required to transmit a file from the computer described above, a transmission ending linkage on/off control tab 509 receives linkage information with a file handle, which is generated upon the transmission of the file in a device driver for data storage means control apparatuses 200, 210, 300, and 320 according to the present invention installed on the computer and disappears upon the completion of the transmission, by the wireless interface method from connector 403 for combined use as a charging terminal and an USB interface of the smartphone 400 from the computer or the wireless interface dongle (not illustrated) installed on the USB port provided on the rear I/O panel of the computer, thereby switching the access permission state to the data storage means control apparatuses 200, 201, 300, and 302 according to the present invention to the access blocking state while completing the transmission of the file.

The access control configuration control tab 511 presets whether to permit the access only to the read operation, only to the write operation, or to both the read and write operations according to a detailed configuration, and transmits the access information configured for the data storage means control apparatuses 200, 210, 300, and 320 according to the present invention, thereby performing the operation of permitting or blocking the access.

When the user is away from the computer by a certain distance or more and communication is hardly made between the smartphone 400 of the user and the data storage means control apparatuses 200, 210, 300, and 320 according to the present invention in which the wireless communication unit 201 is embedded, the access control configuration information previously set is saved in an arbitrary register of the smartphone software 500 for storage device control of the present invention, and then all the access setting values for the read operation and the write operation are switched to the access blocking state, and when the user is again located within the use range in front of the computer, the configured access control information is restored from the arbitrary register that is saved and switched to the original state.

Hereinabove, the exemplary embodiments according to the present invention have been described in detail, but those skilled in the art may implement various changes and modifications without departing from the scope of the claims.

### INDUSTRIAL APPLICABILITY

The present invention provides a disk security level similar to enhancing security through an additional personal authentication procedure by inputting numbers through an automatic response system (ARS) or text through a social networking service (SNS) with a smartphone of a user as a heterogeneous information device that is separated from a network in addition to using a public certificate or a transfer password on the computer in the case of the remittance of a large amount of more than a certain amount set in advance like a Internet banking environment operating in a high-level security environment.

1. A data storage means control apparatus having a data protection function by using wireless communication with a smartphone, the data storage means control apparatus comprising:
a printed circuit board including one or more connection means exposed to the outside and a data storage means or a connection means connected to the data storage means;
a first connector unit which is connected to a computer and to which a main data bus is connected among the connection means exposed to the outside;
a data bus switch unit configured to connect the main data bus to the first connector unit and the data storage means or disconnect the main data bus therefrom; and
a wireless communication unit connected to a smartphone of a user by a wireless interface and output an on or off control signal to the data bus switch unit according to a data access permission or blocking signal transmitted from the smartphone by the user,
wherein an access control function is performed for the data storage means in a manner in which an operation of connecting or disconnecting the main data bus is performed.

2. The data storage means control apparatus of claim 1, wherein the data storage means is any one of an M.2 solid state drive (SSD), an M.3 SSD, a 2.5-inch SSD, a 3.5-inch SSD, and a peripheral component interconnect express (PCIe) Add-in card type SSD which are an independent type.

3. The data storage means control apparatus of claim 1, wherein the data storage means includes a solid state drive (SSD) controller and an arrangement form of nonvolatile memory devices.

4. The data storage means control apparatus of claim 3, wherein the main data bus is connected or disconnected to or from the SSD controller and the first connector unit or to or from the SSD controller and the arranged nonvolatile memory elements.

5. The data storage means control apparatus of claim 1, wherein, when a control unit for controlling redundant arrays of inexpensive disk (RAID) or a peripheral component interconnect express (PCIe) switch is further provided between the first connector unit and the connection means connected to the data storage means, a bus switch is further provided between the first connector unit and the control unit, and the bus switch is turned on or off by an output signal of the wireless communication unit.

6. The data storage means control apparatus of claim 1, wherein, when a control unit for controlling redundant arrays of inexpensive disk (RAID) or controlling peripheral component interconnect express (PCIe) switch is further provided between the first connector unit and the connection means connected to the data storage means and the control unit is provided with an externally controlled main data bus enable pin, the control unit connects the main data bus enable pin to the wireless communication unit so that the main data bus is connected or disconnected.

7. The data storage means control apparatus of claim 1, wherein, when a control unit for controlling redundant arrays of inexpensive disk (RAID) or a peripheral component interconnect express (PCIe) switch is further provided between the first connector unit and the connection means connected to the data storage means, a bus switch is further provided between the connector unit and the connection means connected to the data storage means, and the bus switch is turned on or off by an output signal of the wireless communication unit.

8. The data storage means control apparatus of claim 1, wherein the wireless communication unit communicates with the smartphone of the user by Bluetooth or Wi-Fi as a wireless interface.

9. The data storage means control apparatus of claim 8, wherein the wireless communication unit includes an internal antenna when the data storage means control apparatus is installed in a 3.5-inch bay and includes an external antenna provided outside a peripheral component interconnect express (PCIe) bracket when the data storage means control apparatus is installed in a PCIe slot connector.

10. The data storage means control apparatus of claim 1, wherein, when the data storage means control apparatus is a solid state drive (SSD) doubler or an SSD tripler installed in a 3.5-inch bay, the wireless communication unit or a wireless communication module constituting the wireless communication unit is provided on a lower end surface of the printed circuit board.

11. The data storage means control apparatus of claim 10, further comprising a protrusion preventing cover provided on a lower end surface of the data storage means control apparatus to prevent the protruding wireless communication unit or wireless communication module from protruding to the outside, in order that there is no protrusion outside the lower end surface of the data storage means control apparatus.

12. The data storage means control apparatus of claim 11, wherein the protrusion preventing cover is configured so that only an antenna portion of the wireless communication unit or the wireless communication module is exposed to the outside.

13. A data storage means control method of a data storage means control apparatus having a data protection function by using wireless communication with a smartphone, the data storage means control method comprising performing an access control function for a data storage means in a manner in which an operation of connecting or disconnecting a main data bus is performed,
wherein the data storage means control apparatus includes:
a printed circuit board including one or more connection means exposed to the outside and the data storage means or a connection means connected to the data storage means;
a first connector unit which is connected to a computer and to which the main data bus is connected among the connection means exposed to the outside;
a data bus switch unit configured to connect the main data bus to the first connector unit and the data storage means or disconnect the main data bus therefrom;
a wireless communication unit connected to a smartphone of a user by a wireless interface and output an on or off control signal to the data bus switch unit according to a data access permission or blocking signal transmitted from the smartphone by the user; and
control software installed on the smartphone of the user to perform a configuration or control operation for the computer, the wireless communication unit, or the data bus switch unit.

14. The data storage means control method of claim 13, wherein the control software sets activation or deactivation of the wireless communication unit, and when the deactivation of the wireless communication unit is set, a bus switch constituting the data bus switch unit is kept in an off state to block access from others.

15. The data storage means control method of claim 13, wherein the control software transmits, to the computer, an on or off configuration signal of a virtual storage device for selecting whether the virtual storage device for the data storage means control apparatus is exposed on the computer to which the data storage means control apparatus is connected.

16. The data storage means control method of claim 15, wherein, when the virtual storage device is configured to not be exposed, the configuration is displayed on the computer in a detailed menu to allow the user to designate a Hot-Key for exposure, and when the virtual storage device is exposed on the computer but only a search window corresponding to the virtual storage device is not exposed, an open confirmation button of the search window pops up on a screen of the smartphone of the user in a state in which the virtual storage device is double-clicked to allow the user to press the confirmation button so as to open the search window.

17. The data storage means control method of claim 13, wherein, when an access operation for the data storage means control apparatus is generated on the computer, the control software controls the data bus switch unit to be kept in an on or off state by allowing the user to operate the smartphone according to a preset operation start security configuration.

18. The data storage means control method of claim 17, wherein the control software determines whether to perform the access operation for the storage device by a simple touch on a display screen and at least one recognition means among recognition means using biometric recognition including palm recognition, fingerprint recognition, and facial recognition according to a security configuration of the user, as the operation start security configuration.

19. The data storage means control method of claim 17, wherein the control software blocks an operation by a preset timer value after the access operation for the data storage means control apparatus proceeds by a manipulation of the user according to the operation start security configuration.

20. The data storage means control method of claim 19, wherein the timer value is updated to a value generated by a time required to transmit a file from the computer.

21. The data storage means control method of claim 17, wherein the control software switches the data bus switch unit to the on state by the manipulation of the user according to the operation start security configuration so that the access operation for the data storage means control apparatus proceeds, and after the access operation is completed, receives an access operation complete bit transmitted through an interface connector connected to the computer by a wire or wireless interface means provided on the computer to switch the data bus switch unit to the off state.

22. The data storage means control method of claim 21, wherein the access operation complete bit is generated according to the time required to transmit the file from the computer or in association with a file handle according to the transmission of the file.

23. The data storage means control method of claim 17, wherein the control software receives information on the access to the data storage means control apparatus transmitted from the computer to which the data storage means control apparatus is connected through a wireless interface means provided on the computer to select whether to perform access control only for a read operation, access control only for a write operation, or access control for both the read operation and the write operation.

24. The data storage means control method of claim 13, wherein, when communication with the data storage means control apparatus approaches a state where communication is not performable, the control software stores various types of preset configuration information in an arbitrary register and then switches both access setting values for a read operation and a write operation to an access blocking state, and when the communication with the data storage means control apparatus becomes smooth, the control software restores the configured access control information from the stored arbitrary register and switches the restored access control information to an original state.
